(19) United States
(12) Patent Application Publication
(10) Pub. No.: US 2005/0012951 A1
(43) Pub. Date: Jan. 20, 2005

(54) Printer driver management

(76) Inventors: Robert J. Madril JR., Boise, ID (US); Eugenio G. Walters, Boise, ID (US); Shell S. Simpson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/623,023

(22) Filed: Jul. 18, 2003

(51) Int. Cl. G06F 15/00

(52) U.S. Cl. 358/1.13; 358/1.1; 358/1.9

(57) ABSTRACT

A printer driver is determined according to a received printer identification. A content type that identifies the printer driver and the capabilities of the printer driver is then generated and returned.

### BACKGROUND

Networked computing environments provide an advantage of being able to share network resources among network users. For example, computer users on a network may be given access to various printers on the network through a network server (e.g., a print server). The proliferation of mobile computing devices (e.g., laptop computers, cell phones, PDA's) and network connectivity methods (e.g., Ethernet, Wi-Fi, cellular) likewise can extend the benefits of shared network resources to mobile computing environments. Thus, users operating mobile computing devices may also have access to various shared printers on a network.

One disadvantage with current environments that provide shared printing is the need to maintain a print server or other computer acting as a print server. In order to generate print data compatible with a particular printer model, it is necessary to have an appropriate printer driver available on the print server. In the current print server model, a system administrator manually installs printer drivers for the printer models to which the print server has access (e.g., through a “port”). Access to additional printer models being added to the environment requires that additional printer driver installations be made by the system administrator.

### SUMMARY

Upon receipt of a printer identification, a printer driver is determined that corresponds with the printer identification. A content type that identifies the printer driver and the capabilities of the printer driver is then generated and returned.

### BRIEF DESCRIPTION OF THE DRAWINGS

The same reference numbers are used throughout the drawings to reference like components and features.

FIG. 1 illustrates an exemplary environment for implementing one or more embodiments of a driver management service.

FIG. 2 illustrates a block diagram of an exemplary mobile computing device, an exemplary MEP server, an exemplary printer, and an exemplary content transformation server as might be implemented in the environment of FIG. 1.

FIG. 3 illustrates a block diagram showing an example of information and/or data that may be transferred between a content transformation harness and a driver management service.

FIG. 4 illustrates a block diagram showing an example of information and/or data that may be transferred between a content transformation harness and a translator engine.

FIG. 5 illustrates a block diagram showing an example of information and/or data that may be transferred between a translator engine and a driver management service.

FIG. 6 illustrates a block diagram of another exemplary embodiment of a mobile computing device, an MEP server, a printer, and a content transformation server 106 as might be implemented in the environment of FIG. 1.

FIGS. 7-11 illustrate exemplary methods for implementing one or more embodiments of a driver management service.

### DETAILED DESCRIPTION

Overview

Users of mobile computing devices such as laptop computers, cell phones, and PDA's (Personal Digital Assistants) can forward email attachments and other documents to a Web service for printing on identified printers. A content transformation server associated with the Web service automatically transforms the content into print ready data according to the identified printer. The Web service then sends the print ready data to the identified printer for printing.

The content transformation server includes a driver management service module configured to receive a printer identification and to return an output content type that identifies an appropriate printer driver to convert input content (e.g., a document) into print ready data based on the identified printer. The driver management service determines if the printer driver is installed on the content transformation server, and automatically installs the driver if it is not already installed.

The driver management service also receives a content output type identifying a printer driver and maps the printer driver to a corresponding name of a printer icon in a printer folder. The driver management service returns the printer icon name to a translator engine that uses the printer icon in a print command to print a document to a file. The file containing print ready data is forwarded to an identified printer for printing.

The disclosed system and methods provide advantages that include the automatic installation of an appropriate printer driver for content transformation into print ready data. Client devices (e.g., laptop computers, cell phones, and PDA's) simply pass in a content type and a printer device identification, and the system generates an appropriate output content type for printing on the identified printer.

The subject matter disclosed herein is described with specificity to meet statutory requirements. However, the description itself is not intended to limit the scope of the disclosed subject matter. Rather, the description is written in contemplation that the claimed subject matter might also be embodied in other ways, to include different elements or combinations of elements similar to the ones described in this document, in conjunction with other present or future technologies.

Exemplary Environment

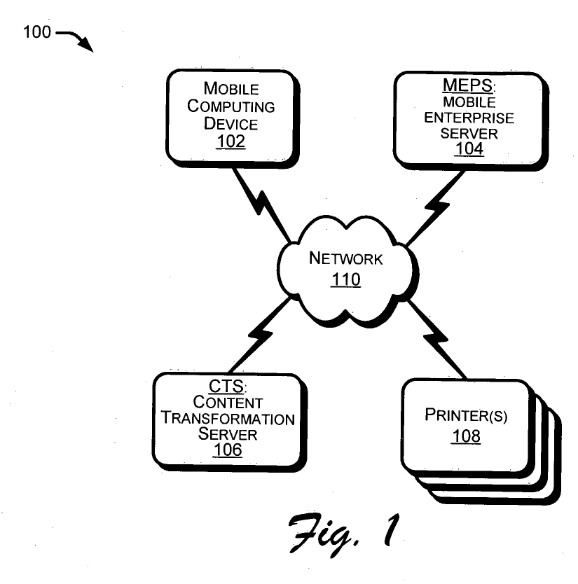

FIG. 1 illustrates an exemplary environment for implementing one or more embodiments of a driver management service. The exemplary environment 100 of FIG. 1 includes a mobile computing device 102, a mobile enterprise server (MEP server) 104, a content transformation server (CTS) 106, and a printer 108 operatively coupled through a network 110. The network 110 can be a direct or indirect link and may include, for example, a printer cable, a LAN (local area networks), a WAN (wide area networks), an intranet, the Internet, or any other suitable communication link. Network 110 can also include a wireless communications link such as an IR (infrared) or RF (radio frequency) link.

Although the MEP server 104 and the CTS 106 are illustrated in the FIG. 1 environment as being physically distributed, the CTS 106 might also be an integral component within the MEP server 104. Therefore, although calls between the MEP server 104 and the CTS 106 are discussed as being network calls, they might also be internal calls between components that are merely logically distributed within the MEP server 104.

Mobile computing device 102 may be implemented as any of a wide variety of PDA's (e.g., Hewlett-Packard's iPAQ, 3Com's PalmPilot, RIM's Blackberry), cell phones, laptop computers, and the like. Mobile computing device 102 may be implemented as a laptop computer running an open platform operating system, such as the Windows® brand operating systems from Microsoft® and various applications for performing common computing functions, such as email, calendaring, task organization, word processing, Web browsing, and so on. However, device 102 is more typically implemented as a smaller, mobile hand-held device such as a PDA, a cell phone, or some combination thereof. Such mobile hand-held devices typically provide more limited computing capabilities such as information storage and retrieval capabilities for personal or business use including keeping schedule calendars and address book information. Such devices usually offer some version of an operating system such as, for example, Windows CE. Various applications are available for such devices that provide limited functionality compared to full-fledged versions available for typical personal computers. Thus, mobile hand-held devices 102 may include limited versions of email, phone, SMS (short message service), organizer and Web applications. The general configuration and operation of such mobile computing devices 102 are well-known to those skilled in the art.

The mobile enterprise server (MEP server) 104 and content transformation server (CTS) 106 are typically implemented as a variety of general purpose computing devices including, for example, some form of personal computer (PC), a workstation computer, a server, a Web server, and so on. The general configuration and operation of such computing devices are well-known to those skilled in the art. In the FIG. 1 environment and embodiments described herein below, MEP server 104 is configured to receive content (e.g., an email with attached document) and information (e.g., a printer identification) from a mobile computing device 102, which it modifies and forwards to CTS 106 for processing. CTS 106 is generally configured to transform the content into print ready data and transfer it back to MEP server 104. The MEP server 104 then transfers the print ready data to a printer identified by device 102. The operation of MEP server 104 and CTS 106 is discussed in more detail with respect to embodiments described herein below.

Printer 108 can be implemented as any of a variety of printer(s) 108 capable of rendering PDL (page description language) data (e.g., Hewlett Packard's Printer Control Language (PCL) or Adobe's Postscript) in printed form on a print medium, such as printing pixels on paper. Therefore, printer(s) 108 can include devices such as laser-based printers, ink-based printers, dot matrix printers, dry medium printers, plotters and the like. In addition, printer(s) 108 might also include various multi-function peripheral (MFP) devices that combine a printing function with other functions such as facsimile transmission, scanning, copying and the like. The general configuration and operation of such devices are well-known to those skilled in the art.

### EXEMPLARY EMBODIMENTS

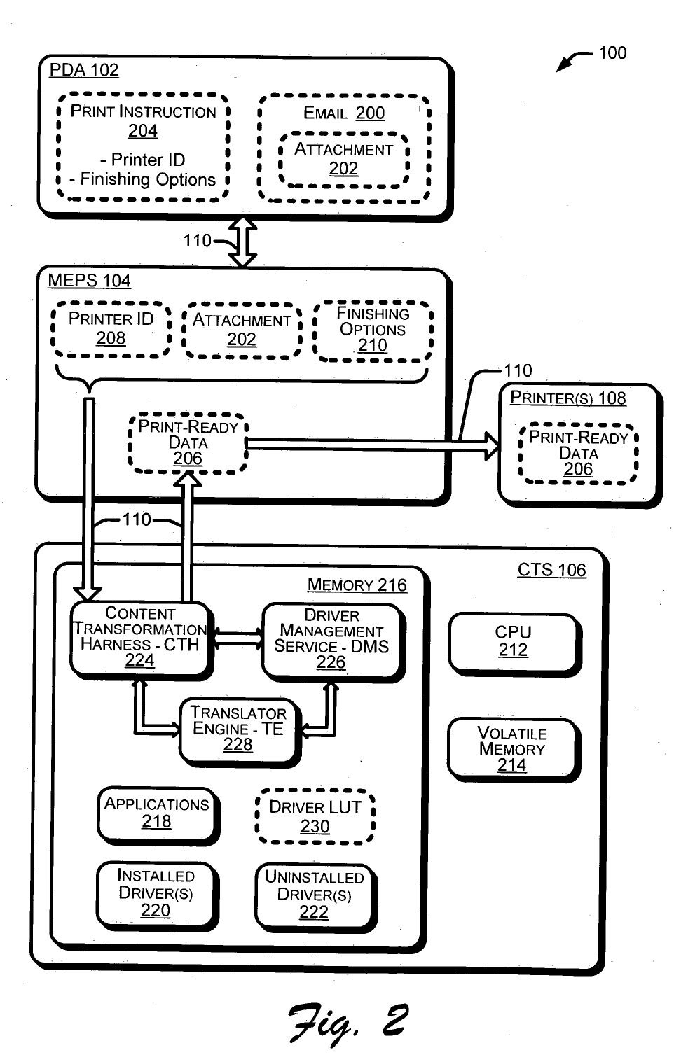

FIG. 2 illustrates a block diagram of one embodiment of an exemplary mobile computing device 102, an exemplary MEP server 104, an exemplary printer 108, and an exemplary content transformation server (CTS) 106. The mobile computing device 102 is implemented in the FIG. 2 embodiment as a PDA 102. The specific configuration and operation of the PDA 102, MEP server 104, and printer 108, will not be discussed, as such devices are generally well-known to those skilled in the art. Rather, these devices are discussed generally with respect to their peripheral involvement in a content transformation process implemented on the CTS 106.

An exemplary content transformation process may be initiated by PDA 102 as follows. PDA 102 (i.e., a user operating PDA 102) receives an email 200 having an attached document 202. The attached document 202 can include various types of documents (e.g., word processing, spread sheet, graphics) in various file formats (e.g., .doc, .xls, and .pdf). A user desiring to print attached document 202 forwards the email 200 and attachment 202 to MEP server 104 along with print instructions 204 that include, for example, a printer identification that identifies a printer 108 on which the attachment 202 should be printed and document finishing options that provide details (e.g., margins, fonts, n-up printing, duplexing) on how the attachment 202 should be printed.

The MEP server 104 receives the print instructions 204 along with the email 200 and its attachment 202. MEP server 104 is configured to separate the attachment 202 from the email 200 and forward the attachment 202 to CTS 106 to be transformed into print-ready data 206 that is compatible with a printer 108 identified by the printer identification 208 from print instructions 204. The printer identification 208 may be in various forms including, for example, a text string specifying a printer model, a text string specifying a printer driver, a UNC (Universal Naming Convention) path identifying a location of the printer driver, and so on. The MEP server 104 is also configured to forward the printer identification 208 and document finishing options 210 (i.e., from the print instructions 204) to the CTS 106 in order to facilitate the transformation of attachment 202 into print-ready data 206. It is noted that an email 200 from PDA 102 may include multiple attachments 202, in which case the MEP server 104 typically forwards each attachment 202 as a separate job, along with a printer ID 208 and finishing options 210, to the CTS 106 for transformation into print-ready data. After the CTS 106 transforms the attachment 202 into print-ready data 206, the MEP server is configured to receive the print-ready data 206 from the CTS 106 and forward it to the appropriate printer 108 as identified by printer identification 208.

The content transformation server (CTS) 106 receives the attachment 202, the printer identification 208 and the document finishing options 210. In general, the CTS 106 is configured to automatically determine an appropriate printer driver for transforming the attachment 202 into print-ready data 206 corresponding with a printer 108 that is identified by the printer ID 208. As discussed in greater detail below, the CTS 106 uses the appropriate printer driver to transform the attachment 202 into print-ready data 206. The CTS 106 may also automatically install the appropriate printer driver for the transformation if the driver is not already installed on the CTS 106.

A content transformation server (CTS) 106 typically includes a processor 212, a volatile memory 214 (i.e., RAM), and a nonvolatile memory 216 (e.g., ROM, hard disk, floppy disk, CD-ROM, etc.). Nonvolatile memory 216 generally provides storage of computer/processor-readable instructions, data structures, program modules and other data for CTS 106. The CTS 106 typically implements various application programs 218 stored in memory 216 and executable on processor 212. Such applications 218 might include software programs implementing, for example, word processors, spread sheets, browsers, multimedia players, illustrators, computer-aided design tools and the like.

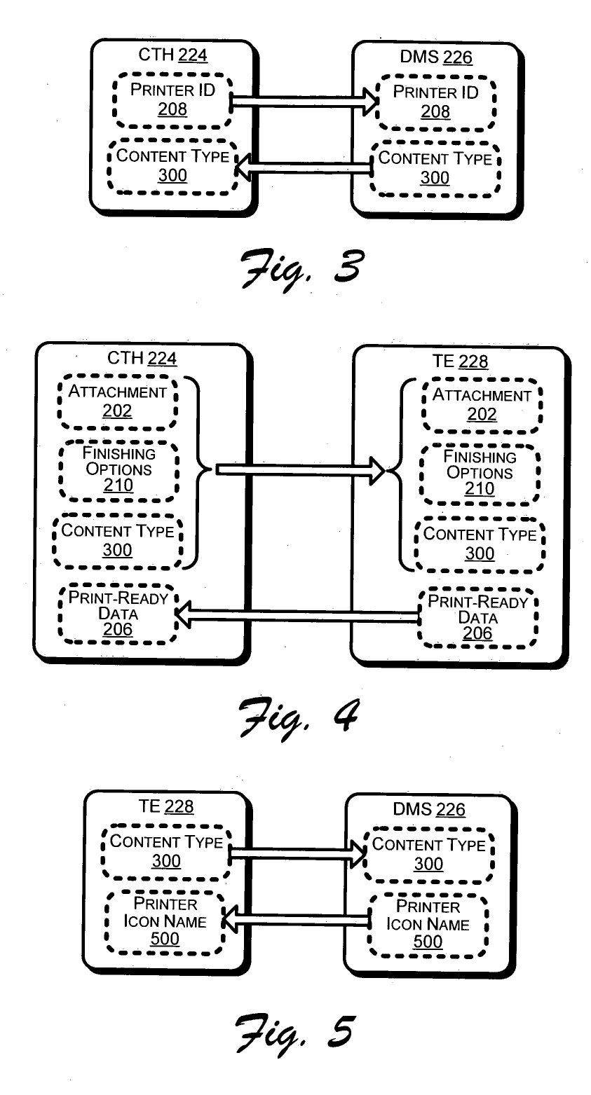

Along with applications 218, CTS 106 also includes a content transformation harness 224, a driver management service 226, and a translator engine 228, stored in memory 216 and executable on processor 212. Content transformation harness 224 is typically a higher level API (application program interface) component configured to receive content, for example, from MEP server 104, and to distribute tasks and content to other lower level components of CTS 106, such as the driver management service 226 and the translator engine 228. FIGS. 3, 4 and 5 illustrate block diagrams showing examples of the information and/or data that may be transferred between the content transformation harness 224, the driver management service 226, and the translator engine 228 during a content transformation process implemented on CTS 106 with respect to the embodiment of FIG. 2.

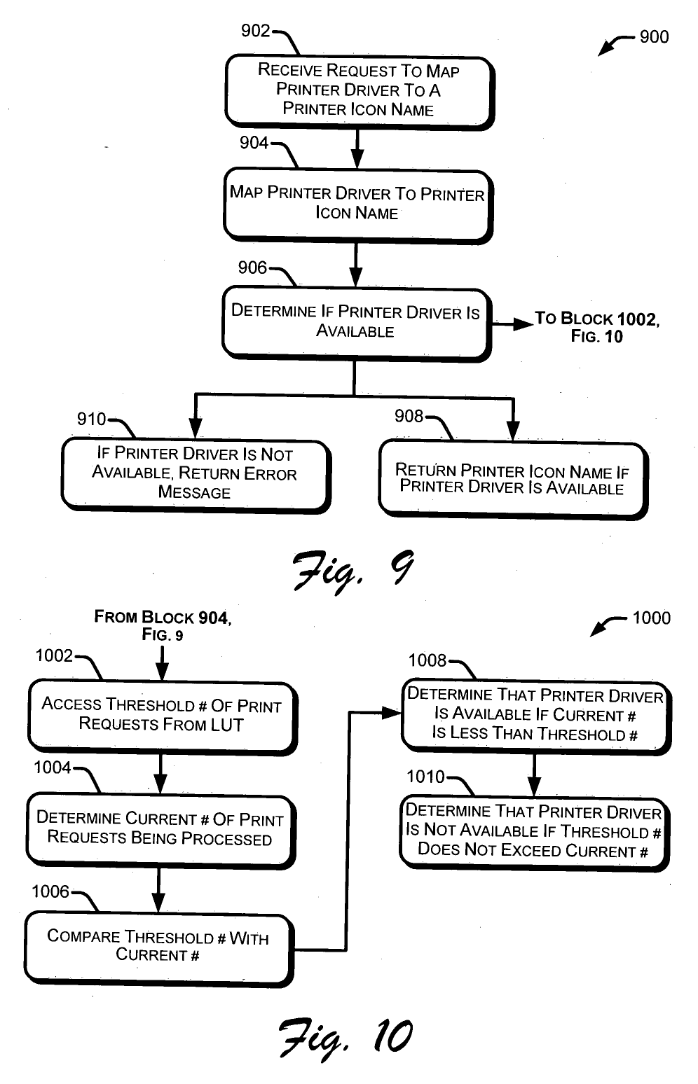

It is noted that additional embodiments are contemplated in which the components of the CTS 106 (i.e., content transformation harness 224, driver management service 226, and the translator engine 228) communicate with one another and with the MEP server 104 in various ways to achieve a similar purpose of automatically transforming content from a mobile computing device 102 into print ready data according to an identified printer. Thus, the embodiment of FIG. 2 and the following related discussion is not intended as a limitation, but rather, is intended as an example. Accordingly, an additional exemplary embodiment is also briefly discussed herein below with respect to the embodiment illustrated in FIG. 6.

Referring again to the FIG. 2 embodiment, content transformation harness 224 is configured to receive an attachment 202, a printer ID 208 and document finishing options 210 from MEP server 104, and to call the driver management service 226 and translator engine 228 to facilitate a transformation of the attachment 202 into print-ready data 206. The content transformation harness 224 is also configured to return the print-ready data 206 back to the MEP server 104. In an alternate implementation, the content transformation harness 224 is configured to return the print-ready data 206 directly to a printer 108. FIG. 3 is intended to illustrate that the content transformation harness 224 sends a request along with the printer ID 208 to the driver management service 226. The content transformation harness 224 is requesting that the driver management service 226 map an appropriate output content type (i.e., a printer driver) for use with a printer 108 identified by the printer ID 208. The harness 224 expects to receive information from the driver management service 226 that identifies a printer driver that can generate print-ready data appropriate for the identified printer 108.

FIG. 3 is also intended to illustrate that the driver management service 226 responds to the request from the content transformation harness 224 by returning a “content type” 300. The content type 300 is a data structure implemented, for example, as an XML (Extensible Markup Language) document. The content type 300 includes information identifying an appropriate printer driver for transforming the attachment 202 into print-ready data 206. The content type 300 XML document may contain an actual printer driver identifier, an actual printer driver name, or a description of the content it wants to have generated by the driver (i.e., without specifically indicating a printer driver or printer icon). The content type 300 also optionally includes information about the capabilities of the printer driver, such as if the driver can provide n-up printing, duplexing, booklet printing, and so on.

Referring generally to FIGS. 2 and 3, the driver management service 226 is configured to receive a printer identification 208 from the content transformation harness 224 and to identify an appropriate printer driver using a driver look-up table (LUT) 230. The driver management service 226 compares the printer ID 208 with a list of printer drivers in the driver LUT 230 to determine which printer driver corresponds with the printer ID 208. The driver management service 226 generates the content type 300, and includes in it, the printer driver found in the driver LUT 230 that corresponds with the printer ID 208. In addition, the driver management service 226 may include the capabilities of the printer driver in the content type 300. It is noted that a LUT is but one way of matching a printer with a printer driver and that other ways are contemplated. For example, the printer identification 208 might be used to obtain a printer model string or driver friendly name. This information can then be compared against the driver friendly names of printers that are available on the CTS 106.

The driver management service 226 additionally determines if the appropriate printer driver (i.e., the driver from the LUT 230 that corresponds with the printer ID 208) is installed on the CTS 106 by searching the installed driver(s) 220. The installed driver(s) 220 may contain one or more printer drivers that have already been installed on CTS 106. The driver management service 226 returns the content type 300 to the content transformation harness 224 when it determines the driver is installed on the CTS 106.

In one implementation of the FIG. 2 embodiment, if the appropriate printer driver (i.e., the driver from the LUT 230 that corresponds with the printer ID 208) is not already installed on the CTS 106, the driver management service 226 installs the driver using files from the uninstalled drivers 222. Uninstalled driver(s) 222 generally includes files that support printer drivers that have not yet been installed on the CTS 106. The driver management service 226 returns the content type 300 to the content transformation harness 224 when the driver is installed on the CTS 106.

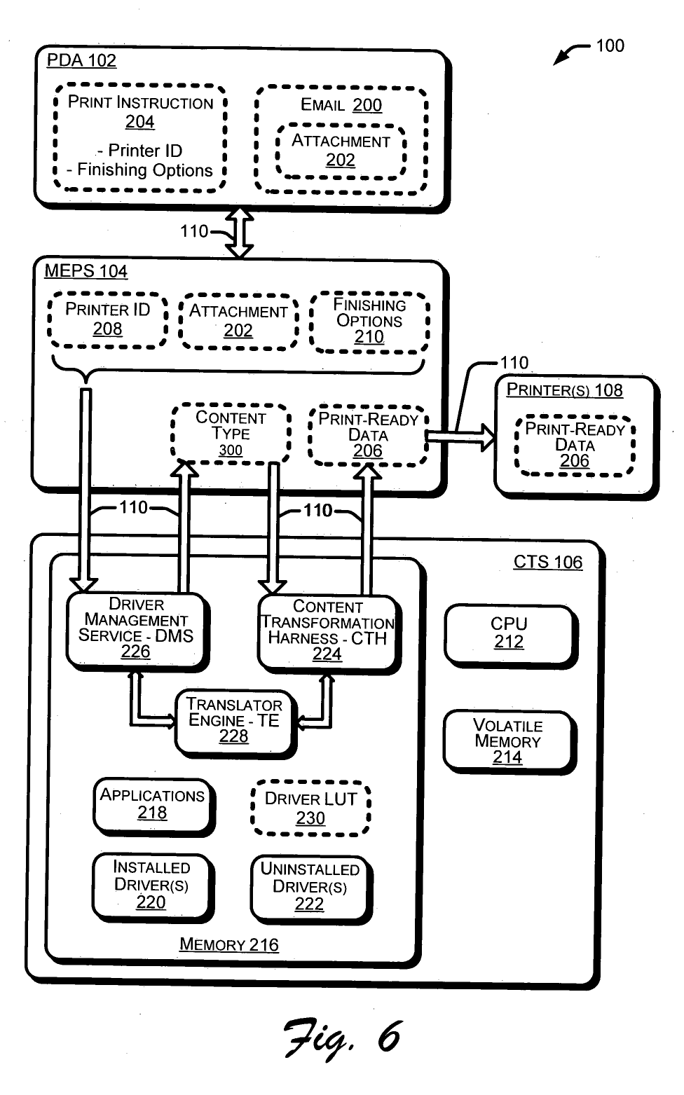

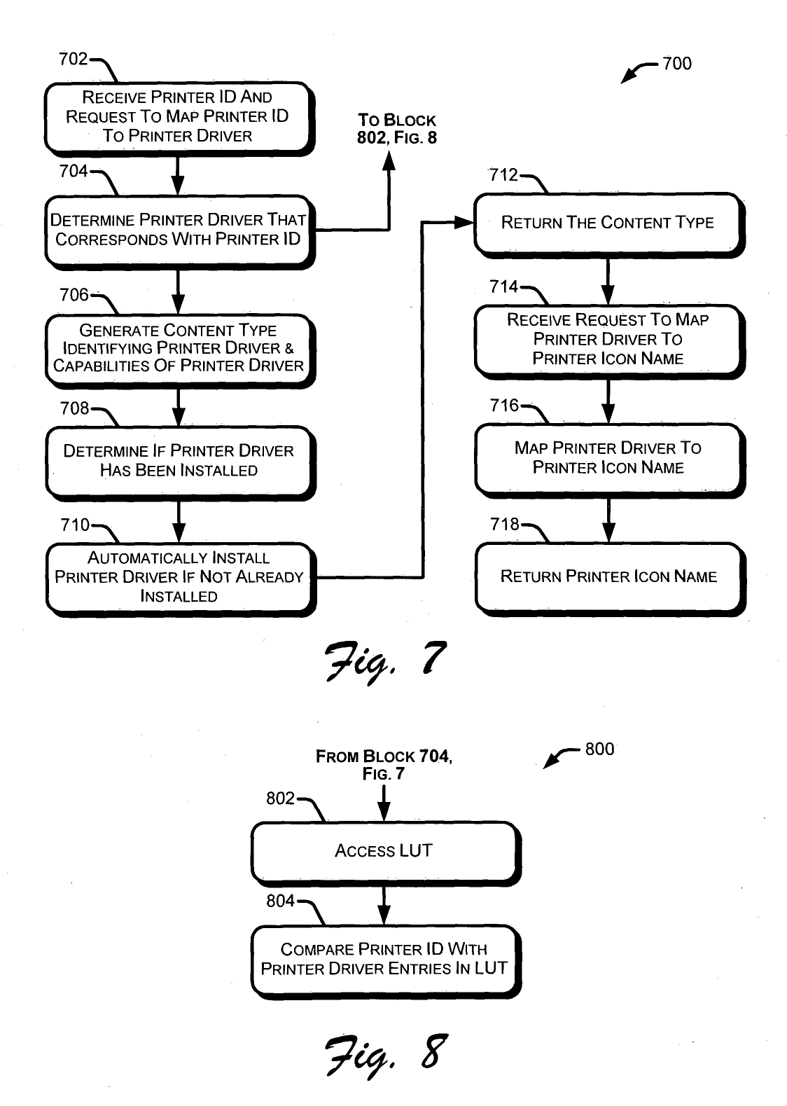

Referring generally to FIGS. 4 and 5 regarding the embodiment of FIG. 2, the content transformation harness 224 transfers the attachment 202, the finishing options 210, and the content type 300 to the translator engine 228. In general, the translator engine 228 translates the attachment 202 into print-ready data 206 using an appropriate printer driver as identified in content type 300, and then transfers the print-ready data 206 back to the content transformation harness 224 as illustrated in FIG. 4.

More specifically, the translator engine 228 automatically opens an application program 218 associated with the attachment 202 in order to perform a file print command to print the attachment 202 to a print-ready data file. For example, if the attachment 202 is a Microsoft Word document, the translator engine 228 will launch/open the Microsoft Word application 218 on CTS 106, and perform a print command within the application 218. The translator engine 228 performs the print command using steps similar to those a user would perform when initiating a print command within an application 218. Thus, the translator engine 228 uses the finishing options 210 to determine what print options to select when performing the print command in the Microsoft Word application 218.

One of the steps the translator engine 228 performs when implementing a print command within an application 218, is to select an appropriate printer icon from within a printer folder. The translator engine 228 has the content type 300 which identifies the appropriate printer driver needed to properly convert the attachment 202. However, on any given CTS 106, the available printers and their associated printer driver icons in the printer folder may be arbitrarily named. For example, the printer folder may contain printer drivers designated as “Printer #1”, “Printer #2”, “Printer #3”, and so on. Therefore, when implementing a print command from within an application 218, the translator engine 228 forwards the content type 300 to the driver management service 226, as illustrated in FIG. 5, and requests that the driver management service 226 map the printer driver from the content type 300 to a printer icon name 500 in a printer folder. The driver management service 226 maps the printer driver to an appropriate printer icon name 500 and, as generally illustrated in FIG. 5, returns the printer icon name 500 to the translator engine 228 for use when implementing a file print command within an application 218.

When the driver management service 226 receives the content type 300 (FIG. 5), it accesses driver LUT 230 to determine the appropriate printer icon name 500 to return to the translator engine 228. Thus, in this implementation, the driver LUT 230 includes information identifying printer drivers with printer names on the CTS 106.

In another implementation of the FIG. 2 embodiment, when the driver management service 226 receives the content type 300 (FIG. 5) from the translator engine 228, it determines that the appropriate printer driver has not yet been installed, and then installs the appropriate printer driver using files from the uninstalled driver(s) 222. In this implementation, it is apparent that the scenario discussed above with respect to FIG. 3 would not already have occurred. Thus, the content type 300 would not have been generated by the driver management service 226, but rather may have been generated by another device, such as, for example, the content transformation harness 224, the MEP server 104, or the PDA 102. In addition, this implementation assumes the possibility that the driver management service 226 generated the content type 300 but did not install the appropriate driver at the time the content type 300 was generated. As in the previous implementation, when the driver management service 226 receives the content type 300 (FIG. 5), it accesses driver LUT 230 to determine the appropriate printer icon name 500 to return to the translator engine 228.

In another implementation of the FIG. 2 embodiment, when the driver management service 226 receives the content type 300 (FIG. 5) from the translator engine 228, it determines that the appropriate printer driver is busy. Some printer drivers have limits on the number of print requests they can manage at the same time. In this implementation, the driver management service 226 accesses the driver LUT 230 to determine the maximum number of print requests the printer driver identified in the content type 300 is capable of managing at one time. The driver management service 226 compares the maximum number of print requests to the current number of print requests that the printer driver is managing. If the maximum number does not exceed the current number, the driver management service 226 will not return a printer icon name 500 to the translator engine 228. Instead, the driver management service 226 may return an error message indicating the requested printer driver is unavailable, or an error message asking the translator engine 228 to try the request again later. If the maximum number exceeds the current number, then the driver management service 226 accesses the driver LUT 230 to determine the appropriate printer icon name 500 to return to the translator engine 228.

In yet another implementation, when the driver management service 226 receives the content type 300 (FIG. 5) from the translator engine 228, it may determine that the printer driver identified by the content type 300 is deficient. In this implementation, the driver management service 226 accesses the driver LUT 230 to determine if the printer driver is deficient. Thus, the driver LUT 230 includes information (e.g., a list of deficient drivers) available to the driver management service 226 that specifies which printer drivers are deficient. A deficient printer driver is typically a printer driver that is known to have problems. The problems may include problems such as installation problems, reliability problems, system lock-up problems during execution, and so on. In this embodiment, if the driver management service 226 determines the printer driver to be deficient, it may return an error message to the translator engine 228 indicating that the printer driver is not available. Alternatively, the driver management service 226 may access the driver LUT 230 to search for an alternate printer driver that may be substituted for the deficient driver. In this embodiment, the driver LUT 230 also includes information about printer drivers that indicates whether or not there are alternate drivers that can be substituted for other drivers, such as deficient drivers. If an alternate driver is available, the driver management service 226 can return a printer icon name 500 to the translator engine 228 that is associated with the alternate driver. As indicated above, the content type 300 XML document may contain an actual printer driver identifier, an actual printer driver name, or a description of the content it wants to have generated by the driver (i.e., without specifically indicating a printer driver or printer icon).

FIG. 6 illustrates another exemplary embodiment of a mobile computing device 102, an MEP server 104, a printer 108, and a content transformation server (CTS) 106. As briefly mentioned above, the components of the CTS 106 (i.e., content transformation harness 224, driver management service 226, and the translator engine 228) can communicate with one another and with the MEP server 104 in various ways to automatically transform content from a mobile computing device 102 into print ready data according to an identified printer 108. The FIG. 6 embodiment provides another such example in addition to that described above regarding the FIG. 2 embodiment.

In general, the components of MEP server 104 and CTS 106 (i.e., content transformation harness 224, driver management service 226, and the translator engine 228) function in a manner like that already described above regarding the embodiment of FIG. 2. Thus, in the FIG. 6 embodiment, the MEP server 104 may receive a request to transform and print some data from a PDA 102 in the form of an email 200 having an attached document 202, along with print instructions 204 that include, for example, a printer identification that identifies a printer 108 on which the attachment 202 should be printed and document finishing options that provide details (e.g., margins, fonts, n-up printing, duplexing) on how the attachment 202 should be printed.

However, in the FIG. 6 embodiment, the MEP server 104 is configured to communicate directly with the driver management service (DMS) 226 component of the CTS 106. The MEP server 104 passes the appropriate information along to the DMS 226 and requests that the appropriate driver be installed for the data transform. The DMS 226 goes through a process similar to that described above to determine if an appropriate printer driver is installed on CTS 106 and return a content type 300 to the MEP server 104. Thus, the DMS 226 receives a printer identification 208 from the MEP server 104 and identifies an appropriate printer driver using driver look-up table (LUT) 230. The DMS 226 compares the printer ID 208 with a list of printer drivers in the driver LUT 230 to determine which printer driver corresponds with the printer ID 208. The DMS 226 generates the content type 300, and includes in it, the printer driver found in the driver LUT 230 that corresponds with the printer ID 208. In addition, the DMS 226 may include the capabilities of the printer driver in the content type 300.

According to the FIG. 6 embodiment, the MEP server 104 then communicates directly with the content transformation harness (CTH) 224 and passes the content type 300 to the CTH 224. The CTH 224 picks an appropriate translator engine 208 and passes the content type 300 to the translator engine 208. In a manner similar to that discussed above regarding the FIG. 2 embodiment, the translator engine 208 generally translates the attachment 202 into print-ready data 206 using an appropriate printer driver and transfers the print-ready data 206 back to the content transformation harness 224. More specifically, the translator engine 228 automatically opens an application program 218 associated with the attachment 202 in order to perform a file print command to print the attachment 202 to a print-ready data file. The translator engine 228 performs the print command using steps similar to those a user would perform when initiating a print command within an application 218. Thus, the translator engine 228 selects an appropriate printer icon from within a printer folder and uses the finishing options 210 to determine what print options to select when performing a print command in the application program 218. The translator engine 228 forwards the content type 300 to the driver management service 226 and requests that the driver management service 226 map the printer driver from the content type 300 to a printer icon name in a printer folder. The driver management service 226 maps the printer driver to an appropriate printer icon name and returns the printer icon name to the translator engine 228 for use when implementing a file print command within an application 218. The translator engine 228 transfers the print-ready data 206 back to the CTH 224 as illustrated in FIG. 6, which in turn, transfers it to the MEP server 104.

Exemplary Methods

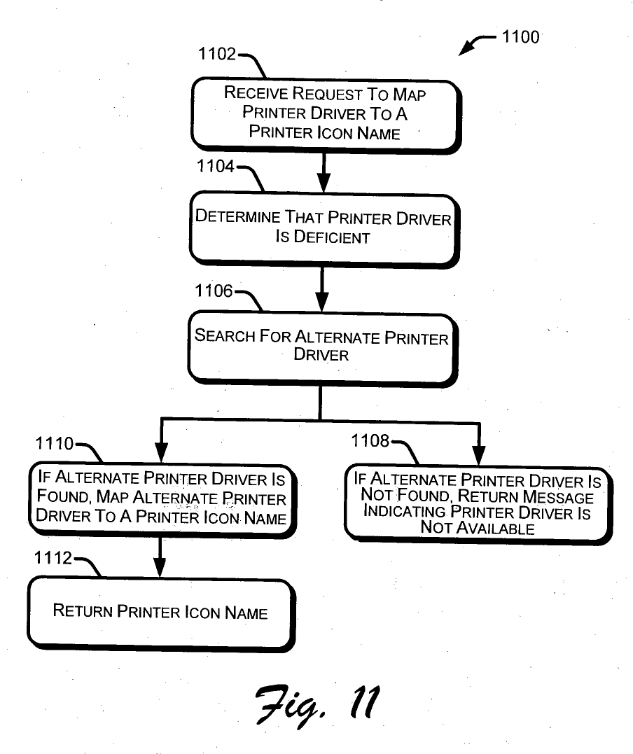

Example methods for implementing one or more embodiments of a driver management service on, for example, a content transformation server, will now be described with primary reference to the flow diagrams of FIGS. 7-11. The methods apply generally to the exemplary embodiments discussed above with respect to FIGS. 2-6. The elements of the described methods may be performed by any appropriate means including, for example, by hardware logic blocks on an ASIC or by the execution of processor-readable instructions defined on a processor-readable medium.

A “processor-readable medium,” as used herein, can be any means that can contain, store, communicate, propagate, or transport instructions for use by or execution by a processor. A processor-readable medium can be, without limitation, an electronic, magnetic, optical, electromagnetic, infrared, or semiconductor system, apparatus, device, or propagation medium. More specific examples of a processor-readable medium include, among others, an electrical connection (electronic) having one or more wires, a portable computer diskette (magnetic), a random access memory (RAM), a read-only memory (ROM), an erasable programmable-read-only memory (EPROM or Flash memory), an optical fiber (optical), and a portable compact disc read-only memory (CDROM) (optical).

FIG. 7 shows an exemplary method 700 for implementing an embodiment of a driver management service 226 as generally discussed above with respect to the embodiments of FIG. 2-5. At block 702, a driver management service 226 receives a printer identification 208 and a request to map the printer ID 208 to a printer driver that is appropriate for the printer 108 identified by the printer ID 208. The printer identification 208 and request to map the printer ID 208 are received from a content transformation harness 224 executing on a content transformation server 106. The printer identification 208 may be in various forms including, for example, a text string specifying a printer model, a text string specifying a printer driver, a UNC (Universal Naming Convention) path identifying a location of the printer driver, and so on. At block 704, the driver management service 226 determines a printer driver that corresponds with the printer ID 208. Block 704 refers to the method 800 of FIG. 8, for a method of determining the printer driver that corresponds with the printer ID 208.

Referring briefly to the method 800 of FIG. 8, at block 802, the driver management service 226 accesses a printer driver look-up table (LUT) 230. The LUT 230 includes information for matching identified printers with corresponding printer drivers. At block 804, the driver management service 226 compares the printer ID 208 with printer driver entries in the LUT 230 in order to determine a printer driver that corresponds with the printer 108 identified by the printer ID 208. As indicated above, an alternate implementation uses the printer ID 208 to obtain a printer model string of the friendly name of an existing printer driver. If the printer ID 208 is an IP address, for example, the printer model string can be obtained by performing standard SNMP queries. If the printer ID 208 is an UNC address, the friendly name of the printer driver associated with the UNC can be obtained via an API call. Using either the model string or the friendly name, it is possible to establish a match with the friendly name of available drivers and install an appropriate driver.

Continuing again with the method 700 of FIG. 7, at block 706, the driver management service 226 generates a content type 300 that identifies a printer driver and the capabilities of the printer driver. As mentioned above, the content type 300 is a data structure that may be implemented, for example, as an XML (Extensible Markup Language) document. The content type 300 may include information identifying an appropriate printer driver that corresponds with the printer ID 208. Alternatively, the content type 300 may include information identifying the type of data generated by the printer driver, such as Postscript version 3.0, suitable for a LaserJet 4200. The content type 300 also may include information about the capabilities of the printer driver, such as if the driver can provide n-up printing, duplexing, booklet printing, and so on.

At block 708 of method 700, the driver management service 226 determines if the printer driver has been installed. In the above described embodiments, the driver management service 226 is described as executing on a content transformation server 106, and the driver management service 226 typically determines whether the printer driver has been installed on the content transformation server 106 or other device on which the driver management service 226 is executing. The driver management service 226 typically accesses the installed drivers 220 on the content transformation server 106 to determine whether the identified printer driver has been installed. At block 710, the driver management service 226 automatically installs the printer driver if it has not already been installed. The driver management service 226 typically accesses uninstalled driver files 222 on the content transformation server 106 in order to install the identified printer driver.

At block 712, the driver management service 226 returns the content type to the content transformation harness 224.

At block 714, the driver management service 226 receives a request to map a content type 300 to a printer icon name 500. The printer icon name 500 is typically one of several printer icon names in a print folder on a computer system such as content transformation server 106. The request and the content type 300 are typically sent to the driver management service 226 by a translator engine 228 executing on a content transformation server 106. However, the content type 300 may also be sent to the driver management service 226 by some other device. At block 716, the driver management service 226 maps the content type 300 to a printer icon name 500, and at block 718, returns the printer icon name 500 to the translator engine 228.

FIG. 9 shows another exemplary method 900 for implementing an embodiment of a driver management service 226 as generally discussed above with respect to the embodiments of FIG. 2-5. At block 902, a driver management service 226 receives a request to map a content type 300 to a printer icon name 500. At block 904, the driver management service 226 maps the content type 300 to a printer icon name 500. At block 906, the driver management service 226 determines whether or not the printer driver corresponding to the content type 300 is available. Because some printer drivers have limits on the number of print requests they can manage at the same time, the driver management service 226 may determine that the printer driver is too busy to manage additional print requests. Block 906 refers to method 1000 of FIG. 10 (discussed below) as an example of how the driver management service 226 may determine whether or not the printer driver is available.

At block 908 of method 900, the driver management service 226 returns the printer icon name 500 if it determines that the printer driver is available. At block 910, the driver management service 226 returns an error message if the printer driver is not available. The error message may include, for example, a message indicating that the printer driver is unavailable or a message indicating that the printer driver is temporarily unavailable and that the request should be attempted at some later time.

As mentioned, FIG. 10 is a block diagram that is a continuation from block 906 of method 900 and provides an example method of how the driver management service 226 may determine whether or not the printer driver is available. At block 1002, the driver management service 226 accesses a threshold number of print requests that a printer driver can manage at the same time. The driver management service 226 locates the threshold number in, for example, a printer driver look-up table (LUT) 230. At block 1004, the driver management service 226 determines the current number of print requests currently being processed by the print driver. At block 1006, the driver management service 226 compares the threshold number with the current number, and determines that the printer driver is available if the current number is less than the threshold number, as shown in block 1008. However, as shown in block 1010, the driver management service 226 determines that the printer driver is not available if the threshold number does not exceed the current number.

FIG. 11 shows another exemplary method 1100 for implementing an embodiment of a driver management service 226 as generally discussed above with respect to the embodiments of FIG. 2-6. At block 1102, a driver management service 226 receives a request to map a content type 300 to a printer icon name 500. At block 1104, the driver management service 226 determines that the printer driver is deficient. Typically, the driver management service 226 accesses the driver LUT 230 to determine if the printer driver is deficient. A printer driver may be on a list of deficient drivers in LUT 230 if it is known to have problems. Problems may include installation problems, reliability problems, system lock-up problems during execution, and so on.

At block 1106 of method 1100, the driver management service 226 searches for an alternate printer driver that can be used as a substitute for the deficient printer driver determined from block 1104. The driver management service 226 typically searches for an alternate printer driver in a driver LUT 230 that includes information indicating whether printer drivers have alternate printer drivers and which drivers can be used as alternate printer drivers. At block 1108, if an alternate printer driver is not found, the driver management service 226 returns a message indicating the printer driver is not available. At block 1110, if an alternate printer driver is found, the driver management service 226 maps the alternate printer driver to a printer icon name 500. At block 1112, the driver management-service 226 returns the printer icon name 500 mapped for the alternate printer driver.

While one or more methods have been disclosed by means of flow diagrams and text associated with the blocks of the flow diagrams, it is to be understood that the blocks do not necessarily have to be performed in the order in which they were presented, and that an alternative order may result in similar advantages. Furthermore, the methods are not exclusive and can be performed alone or in combination with one another.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A processor-readable medium comprising processor-executable instructions configured for:
receiving a printer identification;
generating a content type that identifies output that is compatible with a printer identified by the printer identification; and
returning the content type.

2. A processor-readable medium as recited in claim 1, further comprising processor-executable instructions configured for:
determining a printer driver that corresponds with the printer identification; and
including in the content type, information identifying the printer driver.

3. A processor-readable medium as recited in claim 2, further comprising processor-executable instructions configured for:
determining if the printer driver has been installed; and
automatically installing the printer driver if the printer driver has not already been installed.

4. A processor-readable medium as recited in claim 2, wherein the determining comprises:
accessing a lookup table; and
comparing the printer identification with printer driver entries in the lookup table.

5. A processor-readable medium as recited in claim 2, further comprising processor-executable instructions configured for:
receiving a request to map a printer icon name to the content type;
mapping a printer icon name based on the content type; and
returning the printer icon name.

6. A processor-readable medium as recited in claim 5, wherein the printer icon name identifies a printer icon in a printer folder and the printer icon in the printer folder corresponds with the printer driver.

7. A processor-readable medium as recited in claim 1, wherein the content type is a structured XML (Extensible Markup Language) document.

8. A processor-readable medium as recited in claim 1, wherein the content type comprises information selected from the group comprising:
information identifying a printer driver;
information identifying capabilities of a printer driver;
information describing output that is compatible with the printer;
information describing a compatible printer page description language; and
information identifying a compatible printer.

9. A processor-readable medium as recited in claim 1, wherein the receiving a printer identification includes receiving a request to map the printer identification to a content type.

10. A processor-readable medium as recited in claim 1, wherein the printer identification is selected from the group comprising:
a text string specifying a printer model;
a text string specifying the printer driver; and
a UNC (Universal Naming Convention) path identifying a location of the printer driver.

11. A processor-readable medium comprising processor-executable instructions configured for:
receiving a request to map a printer icon name to a content type;
mapping a printer icon name to the content type;
determining that a printer driver associated with the printer icon name is deficient;
searching for an alternate printer driver;
if an alternate printer driver is found, mapping an alternate printer icon name associated with the alternate printer driver; and
returning the alternate printer icon name.

12. A processor-readable medium as recited in claim 11, further comprising processor-executable instructions configured for returning a message indicating that the printer driver is not available if an alternate printer driver is not found.

13. A processor-readable medium as recited in claim 11, wherein the determining comprises:
accessing a lookup table; and
comparing the printer driver with entries in the lookup table.

14. A processor-readable medium comprising processor-executable instructions configured for:
receiving a request to map a printer icon name to a content type;
mapping a printer icon name to the content type;
determining if a printer driver associated with the printer icon name is available; and
returning the printer icon name if the printer driver is available.

15. A processor-readable medium as recited in claim 14, further comprising processor-executable instructions configured for returning an error message if the printer driver is not available.

16. A processor-readable medium as recited in claim 15, wherein the error message is selected from the group comprising:
a message indicating that the printer driver is unavailable; and
a message indicating that the printer driver is temporarily unavailable and that the request should be attempted later.

17. A processor-readable medium as recited in claim 14, wherein the determining comprises:
comparing a threshold number of print requests to a current number of print requests;
determining that the printer driver is available if the current number is less than the threshold number; and
determining that the printer driver is not available if the threshold number does not exceed the current number.

18. A processor-readable medium as recited in claim 17, wherein the comparing comprises:
accessing the threshold number from a look-up table; and
determining the current number according to active print requests being processed by the printer driver.

19. A processor-readable medium as recited in claim 14, further comprising processor-executable instructions configured for:
determining if the printer driver has been installed; and
automatically installing the printer driver if the printer driver has not already been installed.

20. A method comprising:
receiving a printer identification;
generating a content type that identifies output compatible with a printer identified by the printer identification; and
returning the content type.

21. A method as recited in claim 20, further comprising:
determining a printer driver that corresponds with the printer identification; and
including in the content type, information identifying the printer driver.

22. A method as recited in claim 21, further comprising:
determining if the printer driver has been installed; and
automatically installing the printer driver if the printer driver has not already been installed.

23. A method comprising:
receiving a request to map a printer icon name to a content type;
mapping a printer icon name to the content type;
associating a printer driver with the printer icon name;
comparing a threshold number of print requests for the printer driver to a current number of print requests being executed by the printer driver;
determining that the printer driver is available if the current number is less than the threshold number;
determining that the printer driver is not available if the threshold number does not exceed the current number; and
returning the printer icon name if the printer driver is available.

24. A method as recited in claim 23, further comprising returning an error message if the printer driver is not available, the error message selected from the group comprising:
a message indicating that the printer driver is unavailable; and
a message indicating that the printer driver is temporarily unavailable and that the request should be attempted later.

25. A method comprising:
receiving a request to map a printer icon name to a content type;
determining that a printer driver associated with the printer icon name is deficient; and
returning a message indicating that the printer driver is not available.

26. A method as recited in claim 25, further comprising:
searching for an alternate printer driver;
if an alternate printer driver is found, mapping an alternate printer icon name associated with the alternate printer driver; and
returning the alternate printer icon name for the alternate printer driver.

27. A server comprising:
a content transformation harness configured to receive a document and a printer identification;
a driver management service configured to determine a printer driver corresponding with the printer identification and to install the printer driver if the printer driver is not already installed; and
a translator engine configured to transform the document into print-ready data using the printer driver.

28. A server as recited in claim 27, further comprising:
a content type, generated by the driver management service and containing information indicating the printer driver and capabilities of the printer driver.

29. A server as recited in claim 27, further comprising:
a driver look-up table containing printer driver entries and associated printer identifications, the driver look-up table used by the driver management service to determine a printer driver.

30. A server as recited in claim 27, further comprising:
uninstalled driver files used by the driver management service to install the printer driver if the printer driver is not already installed.

31. A server comprising:
means for receiving a printer identification;
means for generating a content type that identifies output compatible with a printer identified by the printer identification; and
means for returning the content type.

32. A server as recited in claim 31, further comprising:
means for determining a printer driver that corresponds with the printer identification; and
means for including in the content type, information identifying the printer driver.

33. A server as recited in claim 32, further comprising:
means for determining if the printer driver has been installed; and
means for automatically installing the printer driver if the printer driver has not already been installed.

34. A server comprising:
means for receiving a request to map a printer icon name to a content type;
means for mapping a printer icon name to the content type;
means for determining if a printer driver associated with the printer icon name is available; and
means for returning the printer icon name if the printer driver is available.

35. A server as recited in claim 34, wherein the means for determining comprises:
means for comparing a threshold number of print requests for the printer driver to a current number of print requests being processed by the printer driver;
means for determining that the printer driver is available if the current number is less than the threshold number; and
means for determining that the printer driver is not available if the threshold number does not exceed the current number.

36. A server comprising:
means for receiving a request to map a printer icon name to a content type;
means for determining that a printer driver associated with a mapped printer icon name is deficient;
means for locating an alternate printer driver;
means for mapping an alternate printer icon name associated with the alternate printer driver; and
means for returning the alternate printer icon name.
